(19) United States
(12) Patent Application Publication
(10) Pub. No.: US 2026/0055645 A1
(43) Pub. Date: Feb. 26, 2026

(54) VEHICLE DOOR LATCH

(71) Applicant: Minebea AccessSolutions France, Alfortville (FR)

(72) Inventors: François DEBROUCKE, Alfortville (FR); Jean-Marc VERBRUGGHE, Alfortville (FR); Robin DUVAUCHELLE, Alfortville (FR)

(73) Assignee: Minebea AccessSolutions France, Alfortville (FR)

(21) Appl. No.: 19/297,118

(22) Filed: Aug. 12, 2025

(30) Foreign Application Priority Data
Aug. 22, 2024 (EP) 24315386
Aug. 22, 2024 (EP) 24315387
Dec. 19, 2024 (EP) 24315596

(51) Int. Cl. E05B 81/90; E05B 81/06; E05B 81/14; E05B 81/30

(52) U.S. Cl. CPC E05B 81/90; E05B 81/06; E05B 81/14; E05B 81/30

(57) ABSTRACT

A vehicle door latch includes a retention unit to engage with a striker in a closed position and to release the striker in an open position, a central opening lever to rotate around a first shaft between a rest position and an active position, an electric releasing mechanism including an electric gear wheel to be moved by electric releasing motor from a rest position to an active position, the electrical gear wheel displacing the central opening lever, a mechanical release mechanism including a mechanical lever to be displaced between a rest position and an active position. The mechanical lever displaces the central opening lever towards its active position when the mechanical lever is displaced towards its active position. The mechanical lever is rotatably arranged to the central opening lever via a second shaft of the central opening lever different than the first shaft.

### TECHNICAL FIELD

The present invention relates to a vehicle door latch, such as a side door or a trunk lid, comprising an electrical release mechanism also called E-release mechanism.

### BACKGROUND OF THE INVENTION

Nowadays, door latches comprise an electrical release mechanism, also called E-release mechanism, which enables to open the door by a simple pressure on a switch or a movement in front of a detector.

These door latches can be locked and unlocked electrically. The locking function prevents the entrance into the vehicle from the outside.

Such an electrical release mechanism is usually deployed in combination with a manual back up release mechanism corresponding to a conventional door latch wherein the end user directly activates a mechanical opening control that moves a cable which releases a door latch of the door enabling the door to open. There are usually two mechanical opening controls on the door, an inside and an outside handle. In the event of a power failure, these two mechanical opening controls can still be used.

Both the electrical release mechanism and the mechanical backup mechanism should be packed in a reduced space.

Moreover, both mechanisms have to act independently so that the activation of one of the mechanisms does not lead to the activation of the other. In particular, the activation of the E-release mechanism should not lead to a displacement of a manual release lever linked to an inner door handle by a cable. Indeed, the displacement of the manual release lever may lead to the displacement of the inner handle which would be problematic for the user.

Such combination of mechanisms may lead to the axial superimposition of a plurality of levers leading to a large thickness. Such large thickness may render the installation of the latch within the door body difficult.

### SUMMARY OF THE INVENTION

The purpose of the invention is to provide a vehicle door latch combining an E-release mechanism and a manual release mechanism which are independent and have a reduced thickness.

To achieve this goal, the present invention refers to a vehicle door latch comprising:
a retention unit configured for engaging with a striker in a closed position and for releasing the striker in an open position,
a central opening lever configured to rotate around a first shaft between a rest position and an active position wherein the central opening lever releases the retention unit in the open position,
an electric releasing mechanism comprising an electric gear wheel that is configured to be moved by electric releasing motor from a rest position to an active position, the said electrical gear wheel being configured to displace the central opening lever,
a mechanical release mechanism comprising a mechanical lever configured to be displaced between a rest position and an active position, the mechanical lever being configured for displacing the central opening lever towards its active position when the mechanical lever is displaced towards its active position,
wherein the mechanical lever is rotatably arranged to the central opening lever via a second shaft of the central opening lever different than the first shaft.

The use of mechanical lever which is rotatably arranged to the central opening lever via a second shaft of the central opening lever different than the first shaft around which the central opening lever is rotatably arranged enables obtaining a compact door latch combining a mechanical release mechanism and an electrical release mechanism.

According to another embodiment, one of the mechanical lever or the central opening lever comprises an elongated slot and the other of the mechanical lever or the central opening lever comprises a lug configured to be displaced within the elongated slot upon rotation of the central opening lever towards its active position by the electric release mechanism.

According to another embodiment, the elongated slot has an arc shape.

According to another embodiment, the lug is configured to be positioned towards an edge of the elongated slot when the central opening lever and the mechanical lever are in their rest position so that a displacement of the mechanical lever towards its active position leads to a rotation of the central opening lever towards its active position.

According to another embodiment, the mechanical lever comprises an end distant from the second shaft and configured to be linked to a mechanical opening control, such as a handle, via a cable so that a pull on the mechanical opening control leads to the displacement of the mechanical lever towards its active position.

According to another embodiment, the mechanical lever is an inner release lever and the mechanical opening control is an inner handle linked to the cable.

According to another embodiment, the mechanical release mechanism also comprises an outer release lever configured to be linked to a mechanical opening control, such as an outer handle, via a cable, the outer release lever being configured to be displaced from a rest position to an active position to release the retention unit and wherein the vehicle door latch also comprises a locking mechanism comprising an electric locking motor with an output shaft, a worm arranged on the output shaft of the electric locking motor, a locking gear wheel configured to mesh with the worm to be rotated between an unlock position and a lock position and a locking lever configured to be displaced by the locking gear wheel between a first position associated with the lock position of the locking gear wheel wherein the locking lever prevents the outer release lever from putting the retention unit in the released position and a second position associated with the unlock position of the locking gear wheel wherein the outer release lever is enabled to put the retention unit in the released position.

According to another embodiment, Vehicle door latch also comprising an override lever configured to move the locking lever from the locked position to the unlocked position and configured to be driven in movement by the central opening lever from the rest position to the active position or by the inner release lever from the rest position to the active position, the locking lever remaining in the unlocked position after a releasing of the door latch.

According to another embodiment, the override lever is configured to displace the locking lever in the unlocked position before releasing the retention unit in the open position when the central opening lever or the inner release lever is moved from the rest position to the active position to provide a one-motion override release.

According to another embodiment, the override lever is configured to displace the locking lever in the unlocked position without releasing the retention unit in the open position when the central opening lever or the inner release lever is moved from the rest position to the active position to provide a two-motion override release.

The present invention also refers to a vehicle door comprising a vehicle door latch in accordance with one of the previous claims.

The invention will be better understood in view of the following description, referring to the annexed figures in which:

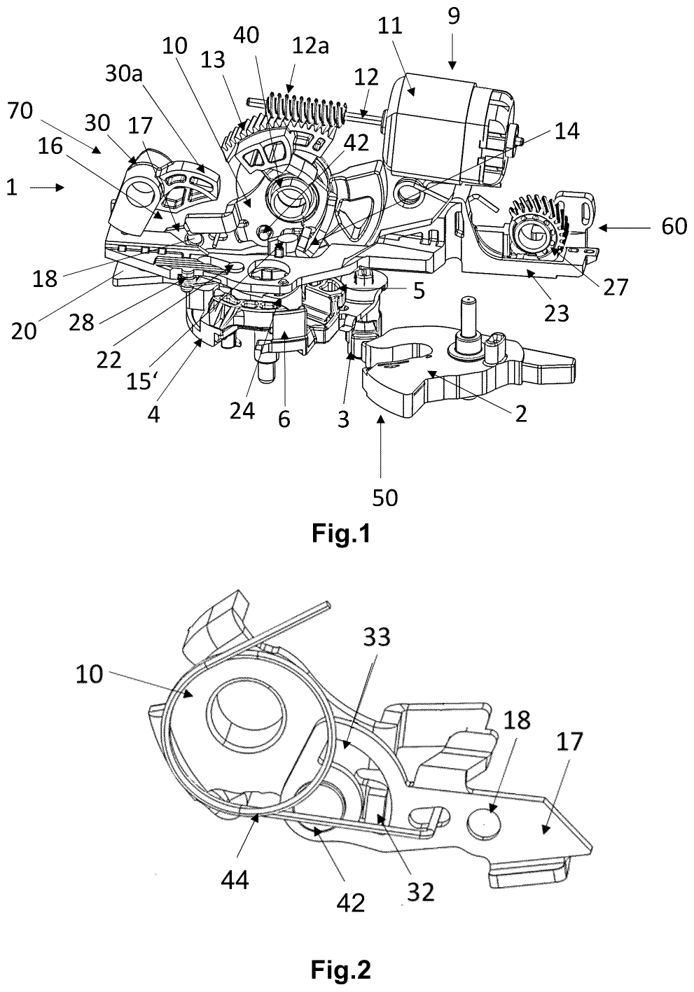

FIG. 1 is a perspective view of some element of a door latch according to an embodiment of the present invention.

FIG. 2 is a perspective view of an inner release lever and a central opening lever of a door latch according to an embodiment of the present invention.

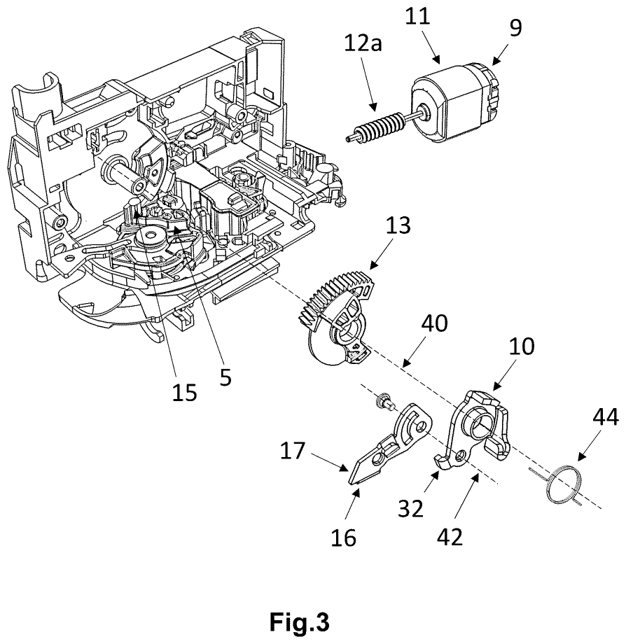

FIG. 3 is a perspective and exploded view of some elements of a door latch according to an embodiment of the present invention.

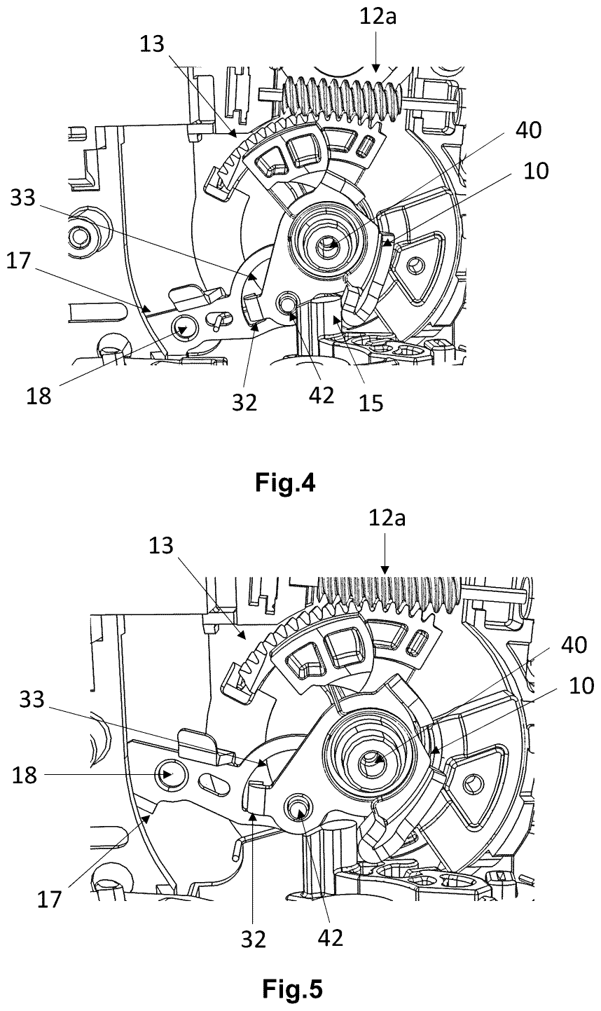

FIG. 4 is a perspective view of a door latch according to an embodiment of the present invention with the inner release lever and the central opening lever in a release position.

FIG. 5 is a similar view of FIG. 4 in case of an inner opening mechanical release.

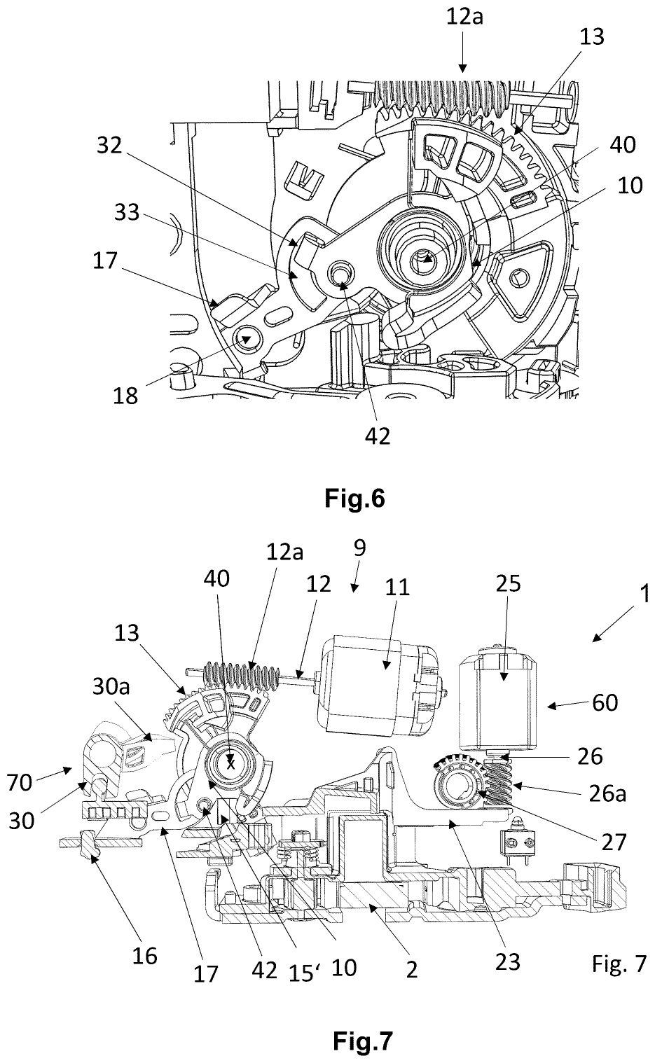

FIG. 6 is a similar view of FIG. 4 in case of an electrical release.

FIG. 7 is a side view of the elements of FIG. 1.

In these figures, identical or similar elements bear the same reference numerals. Only the elements necessary for understanding the invention are shown.

### DETAILED DESCRIPTION OF THE INVENTION

The following achievements are examples. Although the specification refers to one or several embodiments, it does not imply that each reference refers to the same embodiment or that the features apply only to a single embodiment. Simple features of different embodiments can also be combined to provide other embodiments.

FIG. 1 shows an embodiment of a vehicle door latch 1, for closing a door of a vehicle, such as a motor vehicle, in particularly a side door or a trunk lid.

The vehicle door latch 1 comprises a retention unit 50 that comprises a claw 2 and a pawl 3.

The claw 2 and the pawl 3 are both configured to pivot between an open position and a closed position. In the closed position, the retention unit 50 engages with a striker (not represented) of the vehicle, the striker being trapped in the claw 2 and the pawl 3 preventing the rotation of the claw 2. In the open position, the retention unit 50 releases the striker to release the vehicle door latch 1, the pawl 3 allowing the rotation of the claw 2 and the rotation of the claw 2 releasing the striker so the door can be opened.

The pawl 3 may be subjected to an elastic return force which pushes it towards the claw 2. The claw 2 may be subjected to an elastic return force which pushes it in the open position.

The vehicle door latch 1 also comprises an electric releasing mechanism 9. The electric releasing mechanism 9 comprises an electrical gear wheel 13 that is configured to be moved by an electric releasing motor 11 of the door latch 1, from a rest position to an active position.

More precisely here, the electric releasing motor 11 has an output shaft 12 with a worm 12a configured to mesh with the electrical gear wheel 13 so that a rotation of the output shaft 12 leads to the rotation of the electrical gear wheel 13. The electrical gear wheel 13 may comprise teeth only on a portion of circle which depends on the angular difference between the rest position and the active position of the electrical gear wheel 13.

The releasing motor 11 may be activated by a control unit of the vehicle door latch 1 when a user activates an electrical (or electronical) opening control, such as a switch of a door or a key, or a movement in front of a detector. According to an embodiment, the releasing motor 11 is a reversible motor (the output shaft 12 of the release motor 11 can be rotated in a clockwise or a counterclockwise direction, for example to bring the electrical gear wheel 13 back in the rest position after a release of the striker by the vehicle door latch 1).

The vehicle door latch 1 also comprises a central opening lever 10 which is configured to rotate around a first shaft 40 between a rest position and an active position wherein the central opening lever 10 releases the retention unit 50 in the open position.

The central opening lever 10 is driven in active position by the rotation of the electrical gear wheel 13 from its rest position to its active position.

According to an embodiment, the electrical gear wheel 13 and the central opening lever 10 are coaxial. They have a respective end which protrudes axially so the end of the central opening lever 10 is on the path of the end of the electrical gear wheel 13 in the direction of movement of the electrical gear wheel 13 to the active position. Thus, the electrical gear wheel 13 and the central opening lever 10 turn together when the electrical gear wheel 13 is driven to the active position.

The end of the electrical gear wheel 13 is out of the path of the central opening lever 10 when the central opening lever 10 is driven mechanically to its active position (for example by a mechanical lever 17 of a mechanical release mechanism 16 (which will be described in more details in the following of the description) so that the electrical gear wheel 13 is not driven in motion (or not significantly) during a mechanical release.

The central opening lever 10 may be subjected to an elastic return force which pushes it in the rest position.

According to an embodiment represented in FIG. 1 and FIG. 7, the movement of the central opening lever 10 from the rest position to the active position moves a second lever 6 of a driver 4 of the door latch 1.

The second lever 6 may be a pivoting lever. The second lever 6 is configured to move between a rest position and an active position. The first lever 6 may be subjected to an elastic return force which pushes it in rest position.

The driver 4 also comprises a first lever 5. The first lever 5 and the second lever 6 of the driver 4 may have the same axis (coaxial). Depending on the position of a paddle clutch 24 which will be described in more details in the following of the description, the rotation of the second lever 6 towards the active position may lead to the rotation of the first lever 5 in the active position, the first lever 5 being configured to move the pawl 3 in the open position to release the door latch 1.

To rotate the second lever 6 of the driver 4, the central opening lever 10 has for example a tab 14 that cooperates with a pin 15′ of the second lever 6 of the driver 4. Thus, when the central opening lever 10 rotates, the tab 14 pushes the pin 15′, rotating the second lever 6.

The vehicle door latch 1 also comprises a mechanical release mechanism 16. The mechanical release mechanism 16 comprises a mechanical lever 17 (here an inner mechanical lever 17) comprising an end that can be moved by an inner mechanical opening control of the vehicle door (not represented), such as an inner handle, from the inside of the vehicle, from a rest position to an active position. The inner mechanical lever 17 is mechanically linked to the inner mechanical opening control for example by a cable (not represented) for example secured to a hole 18 so that a pull on the mechanical opening control leads to the displacement of the inner mechanical lever 17 towards its active position.

The inner mechanical lever 17 is configured for displacing the central opening lever 10 towards its active position when the inner mechanical lever 17 is displaced towards its active position.

The inner mechanical lever 17 is rotatably arranged to the central opening lever 10 via a second shaft 42 of the central opening lever 10. Such second shaft 42 is different than the first shaft 40. Thus, the central opening lever 10 is configured to rotates around the first shaft 40 and the inner mechanical lever 17 is configured to rotate around the second shaft 42 which is arranged on the central opening lever 10 and is distant from the first shaft 40.

According to an embodiment visible in FIG. 2, the central opening lever 10 has a lug 32 that is moveable in an elongated slot 33, for example in a shape of an arc, of the mechanical lever 17. The lug 32 can be displaced along the elongated slot 33 upon rotation of the central opening lever 10 towards its active position by the electric release mechanism 9.

The mechanical lever 17 may be subjected to an elastic return force which pushes it in a rest position. Such elastic return force may be applied by a spring 44 arranged between the mechanical lever 17 and the central opening lever 10.

Alternatively, the elongated slot 33 may be arranged in the central opening lever 10 and the lug 32 may be arranged on the mechanical lever 17.

The lug 32 can be configured to be positioned towards an edge of the elongated slot 33 when the central opening lever 10 and the mechanical lever 17 are in their rest position so that a displacement of the mechanical lever 17 towards its active position leads to a rotation of the central opening lever 10 towards its active position.

For example, in the rest position of the central opening lever 10 and the mechanical lever 17 represented in FIG. 2 and FIG. 4, the lug 32 of the central opening lever 10 abuts an edge of the elongated slot 33 so that the central opening lever 10 may be driven in movement by the mechanical lever 17 when the mechanical lever 17 is driven in movement from its rest position to its active position as represented in FIG. 5.

Thus, when the user pulls on the inner handle, it moves a cable which is linked to the hole 18 of the inner mechanical lever 17 so that the inner mechanical lever 17 is displaced in the active position. Such displacement of the inner mechanical lever 17 towards the active position goes with the rotation of the central opening lever 10 from the rest position to the active position leading to a release of the striker by the retention unit 50. In case of an electrical release, the central opening lever 10 is driven in rotation by the electrical wheel gear 13 (FIG. 6). This rotation of the central opening lever 10 leads to the rotation of the inner mechanical lever 17 around the second shaft 42 and the displacement of the lug 32 of the central opening lever 10 along the elongated slot 33.

Due to this rotation of the mechanical lever 17 around the second shaft 42, the end of the inner mechanical lever 17 distant from the second shaft 42 and comprising the hole 18 remains substantially motionless. As a consequence, no (or almost no) pulling force is applied on the cable linked to the hole 18 when an electrical release is achieved.

Furthermore, the rotatable arrangement of the inner mechanical lever 17 on a second shaft 42 of the central opening lever 10 which is different than the first shaft 40 around which the central opening lever 10 is rotatably arranged enables limiting the thickness of the vehicle door latch 1 as the mechanical lever 17 is not coaxial with the central opening lever 10 (and the electrical gear wheel 13).

The mechanical release mechanism 16 may also comprise an outer release lever 20 that can be moved from a rest position to an active position by an outer mechanical opening control (not represented) of the vehicle door, such as an outside handle, from the outside of the vehicle. The outer release lever 20 may be mechanically linked to the outer mechanical opening control for example by a cable 21 (visible in FIG. 4) that can be pulled by a user activating the outer mechanical opening control. The outer release lever 20 may be configured to rotate the second lever 6 of the driver 4 towards the active position when the outer release lever 20 is rotated towards its active position.

The vehicle door latch 1 may also comprise a locking mechanism 60 (visible in FIG. 1 and FIG. 7) to prevent entrance into the vehicle from outside. The locking mechanism 60 comprises a locking lever 23 than can move between a locked position and an unlocked position.

The locking lever 23 may be configured to move in translation.

In the unlocked position, the movement of the outer release lever 20 releases the retention unit of the door latch 1, enabling the door to open and in the locked position, the locking lever 23 disengages the outer release lever 20 from the retention unit 50.

More precisely as example, the driver 4 comprises a paddle clutch 24 configured to be moved by the locking lever 23 in a deployed position in the unlocked position of the locking lever 23 and to be moved by the locking lever 23 in a retracted position in the locked position of the locking lever 23.

The paddle clutch 24 may be subjected to an elastic return force which pushes it in the deployed position, for example via spring 28, one end of which is linked to the paddle clutch 24 and the other end is linked to the first lever 5.

According to an embodiment, the paddle clutch 24 is configured to slide in a slot of the first lever 5 between the retracted position and the deployed position.

In the deployed position, the paddle clutch 24 is deployed between the first lever 5 and the second lever 6 of the driver 4 such that the movement of the second lever 6 towards the active position drives the moving of the first lever 5 to move the pawl 3 in the open position to release the door latch 1.

In a retracted position represented in FIG. 1, the paddle clutch 24 is disengaged from between the first lever 5 and the second lever 6 so that the movement of the second lever 6 towards the active position does not lead to a movement of the first lever 5. The door latch 1 is thus not released.

According to an embodiment, to move the paddle clutch 24, the locking lever 23 is configured to drive an axial pin 22 of the paddle clutch 24 by a hole of the locking lever 23, the locking lever 23's hole movement driving the moving of the axial pin 22 of the paddle clutch 24 and thus, the paddle clutch 24. The locking lever's hole may have an oblong shape.

Thus, the moving of the first lever 5 can be driven by the movement of second lever 6 (via the paddle clutch 24 when the paddle clutch 24 is in the deployed position) driven by the outer release lever 20 from the rest position to the active position in the unlocked position of the locking lever 23.

In the closed and locked position, the outer release lever 20 cannot release the door latch 1. The second lever 6 can be driven in rotation by the outer release lever 20 moving from its rest position to its active position but to face radially the paddle clutch 24 (which is in the retracted position), and thus without driving in rotation the paddle clutch 24, and thus, without driving in rotation the first lever 5, and without releasing the door latch 1. When the paddle clutch 24 is in the retracted position, a gap is formed between the first lever 5 and the second lever 6 so that the second lever 6 can rotates towards the active position within the gap without interaction with the first lever 5. The first lever 5 remains therefore in the rest position.

The locking mechanism 60 may also comprise a locking motor 25 (visible in FIG. 7) configured to move the locking lever 23 from the unlocked position to the locked position, for example upon a locking request of the user.

The locking motor 25 has here an output shaft 26 having a worm 26a configured to mesh with a locking gear wheel 27 so that a rotation of the output shaft 26 leads to the rotation of the locking gear wheel 27. The locking gear wheel 27 may comprise teeth only on a portion of circle which depends on the angular difference between the unlocked position and the locked position of the locking gear wheel 27 corresponding to the unlocked position and the locked position of the locking lever 23.

As an example, the locking gear wheel 27 has a rib on one of its faces which is configured to cooperate with the locking lever 23 to move the locking lever 23 in the locked position when the locking gear wheel 27 is rotated by the worm 26a of the output shaft 26 of the locking motor 25 (translation to the left in FIG. 1 or FIG. 7).

The locking motor 25 is configured to be moved from the locked position to the unlocked position by the movement of the locking lever 23 from the locked position to the unlocked position (which may be achieved by an override mechanism 70 as described in the following of the description).

According to an embodiment, the locking motor 25 is a reversible motor (the output shaft 26 of the locking motor 25 can be rotated in a clockwise or a counterclockwise direction) and is configured to move the locking lever 23 from the locked position to the unlocked position, for example upon an unlocking request of the user.

The vehicle door latch 1 may also comprise an override mechanism 70 (visible in FIG. 1 and FIG. 7) in order to unlocked the vehicle door latch 1 when the inner mechanical lever 17 is moved from the rest position to the active position and/or when the central opening lever 10 is moved from the rest position to the active position by the electrical release motor 11.

The override mechanism 70 comprises an override lever 30 that is configured to move the locking lever 23 from the locked position to the unlocked position. The override lever 30 is configured to be driven in movement by the central opening lever 10 (if the override function is applied to both the inner mechanical release and the electrical release) or by the mechanical lever 17 (if the override function is applied only to the inner mechanical release) from the rest position to the active position, intended to release the striker from the retention unit 50 to release the door latch 1.

The override lever 30 may be a pivoting lever. The override lever 30 may be articulated to the locking lever 23.

The override lever 30 remains in the unlocked position after a releasing of the door latch 1, such that the locking lever 23 remains in the unlocked position after a releasing of the door latch 1 whatever the releasing has been initiated mechanically by the activation of the inner mechanical control or electrically by the activation of an electrical opening control.

The override lever 30 can have a beak 30a that is configured to cooperate with an end of the central opening lever 10 or an end of the mechanical lever 17.

According to a first embodiment of the override lever 30, the override lever 30 and especially the shape of its beak 30a, may be conformed to move the locking lever 23 from the locked position to the unlocked position by the central opening lever 10 or by the mechanical lever 17 before the central opening lever 10 disengages the retention unit 50 and releases the door latch 1 (the paddle clutch 24 is moved in the deployed position by the locking lever 23 being moved towards the unlocked position before the second lever 6 has been moved by the central opening lever 10). Thus, unlocking and releasing occur in one same motion.

According to a second embodiment of the override lever 30, the override lever 30 and especially the shape of its beak 30a, may be conformed to drive the moving of the paddle clutch 24 in the deployed position after the second lever 6 has been moved by the central opening lever 10 in the active position wherein the second lever 6 prevents the paddle clutch 24 to move towards the deployed position.

When the override function is applied only to the inner mechanical release, unlocking occurs thus at the first inner opening mechanical release of a locked door latch 1 and releasing may occur at the second inner opening mechanical release (in two motions) or by an outer opening release (subsequent to the first inner opening mechanical release) or by an electrical release (subsequent to the first inner opening mechanical release).

During inner opening mechanical release of a locked door latch 1, the inner mechanical lever 17 is moved in rotation by a user activating the inside handle from inside the vehicle.

The lug 32 of the central opening lever 10 abutting the hole 33 drives the central opening lever 10 in rotation.

The central opening lever 10 thus moves the second lever 6 of the driver 4 in rotation, in the gap located between the second lever 6 and the first lever 5 provided by the absence of paddle clutch 24 (which is in the retracted position), and thus, without driving the first lever 5 in rotation, and therefore without releasing the door latch 1.

The displacement of the mechanical lever 17 leads to the tilt of the override lever 30 (due to the interaction between the end of the mechanical lever 17 and the beak 30a of the override lever 30 when the mechanical lever 17 is moved towards its active position) which moves the locking lever 23 in the unlocked position. However, the second lever 6 has already been moved to face radially the paddle clutch 24, blocking the movement of the paddle clutch 24 in the deployed position. This compresses the paddle clutch 24's spring 28.

When the user releases the inner mechanical opening control, the inner mechanical lever 17 rotates back in rest position releasing the central opening lever 10 and thus the second lever 6 which releases the paddle clutch 24 in the deployed position (under the action of the spring 28).

The door latch 1 is then unlocked.

The user may then release the door latch 1 by pulling a second time the inner mechanical opening control, moving the central opening lever 10 which moves the second lever 6 of the driver 4 in rotation, which moves the first lever 5 via the movement of the paddle clutch 24 which is deployed between the first lever 5 and the second lever 6, disengaging the pawl 3 from the claw 2 to release the door latch 1.

During the inner opening mechanical release, the electrical gear wheel 13 is not moved or not significantly moved. Indeed, the electrical gear wheel 13 is disengaged from the central opening lever 10 when the central opening lever 10 is driven in rotation by the mechanical lever 17 from its rest position to its active position.

During an electrical release of a locked door latch 1, the user activates an electrical opening control, which activates the releasing motor 11. The rotation of the output shaft 12 and the worm 12a of the releasing motor 11 moves the electrical gear wheel 13 in rotation. This rotation engages the central opening lever 10 to rotate it to the active position.

The lug 32 of the central opening lever 10 moves in the hole 33 of the mechanical lever 17 without abutting the hole 33 and thus without driving the mechanical lever 17. Thus, the mechanical lever 17 is not moved or not significantly moved.

Next steps are the same as during inner opening mechanical release.

The central opening lever 10 moves the second lever 6 of the driver 4 in rotation, but without driving the paddle clutch 24, and thus, without driving the first lever 5 in rotation, and therefore without releasing the door latch 1.

The pivoting of the central opening lever 10 may pivot the override lever 30 which moves the locking lever 23 in the unlocked position. However, the second lever 6 has already been moved to face radially the paddle clutch 24, blocking the movement of the paddle clutch 24 in the deployed position. This compresses the paddle clutch 24's spring 28.

The control unit of the door latch 1 then controls the releasing motor 11 to return in the rest position, driving back the electrical gear wheel 13. The releasing motor 11 rotates the electrical gear wheel 13 in the opposite direction, so the central opening lever 10 rotates back releasing the second lever 6 and thus the paddle clutch 24 in the deployed position.

The releasing motor 11 may be controlled by the control unit of the door latch 1 to be activated twice when a user activates an electrical (or electronical) opening control.

In a first time the releasing motor 11 moves the electrical gear wheel 13 from the rest position to the active position for unlocking the door latch 1 and after the releasing motor 11 has returned in the rest position driving back the electrical gear wheel 13, the releasing motor 11 can move a second time the electrical gear wheel 13 from the rest position to the active position for releasing the door latch 1.

According to the control unit programming, releasing may then occur after one or two pressing on the electrical opening control.

The override lever 30 can be driven from the unlocked position to the locked position with the movement of the locking lever 23 to the locked position activated by the locking motor 25.

Alternatively, if the override lever 30 is configured to be driven in movement by the inner mechanical lever 17 from the rest position to the active position and not by the central opening lever 10, then the override mechanism 70 is activated only if a mechanical release is achieved as described previously. In such case, to achieve an electrical release, the vehicle door latch 1 needs first to be unlocked, for example via the locking motor 25.

In another embodiment, the locking lever 23 may be driven directly (without intermediate override lever 30) from the locked position to the unlocked position by the movement of the central opening lever 10 from the rest position to the active position, thus by the central opening lever 10 intending to release the striker from the retention unit 50 to release the door latch 1.

According to an embodiment represented in FIG. 3 and FIG. 4, the movement of the central opening lever 10 from the rest position to the active position moves the first lever 5 of the driver 4 of the door latch 1 which is configured to move the pawl 3 in the open position to release the door latch 1 so that the movement of the central opening lever 10 (by the inner mechanical lever 17 or by the releasing motor 11) towards the active position leads to the release of the door latch 1 whatever the position of the locking mechanism 60. To rotate the first lever 5 of the driver 4, the central opening lever 10 has for example a tab 14 that cooperates with a pin 15 of the first lever 5 of the driver 4. Thus, when the central opening lever 10 rotates, the tab 14 pushes the pin 15, rotating the first lever 5 which releases the door latch 1. The other features may be similar to the embodiment described above. In particular, the outer release lever 20 remains configured to rotate the second lever 6 and the locking lever 23 is configured to move the paddle clutch 24 between the deployed position to authorize the release of the door latch 1 by the outer release lever 20 and the retracted position to prevent the release of the door latch 1 by the outer release lever 20. The override mechanism 70 may be used to prevent a user to be locked outside of the vehicle (after having open the door latch 1 by an inner release or an electrical release).

The present invention also refers to a vehicle door comprising a vehicle door latch 1 as described previously.

Thus, the use of a mechanical lever 17 which is rotatably mounted on a second shaft 42 of the central opening lever 10 different than the shaft 40 around which the central opening lever rotates may enable to reduce the bulkiness of the vehicle door latch without affecting its functioning.

1-11. (canceled)

12. A vehicle door latch, comprising:
a retention unit configured to engage with a striker in a closed position and to release the striker in an open position;
a central opening lever configured to rotate around a first shaft between a rest position and an active position wherein the central opening lever releases the retention unit in the open position;
an electric releasing mechanism comprising an electric gear wheel that is configured to be moved by electric releasing motor from a rest position to an active position, the electrical gear wheel being configured to displace the central opening lever;
a mechanical release mechanism comprising a mechanical lever configured to be displaced between a rest position and an active position, the mechanical lever being configured to displace the central opening lever towards its active position when the mechanical lever is displaced towards its active position,
wherein the mechanical lever is rotatably arranged to the central opening lever via a second shaft of the central opening lever different than the first shaft.

13. The vehicle door latch in accordance with claim 12, wherein one of the mechanical lever or the central opening lever comprises an elongated slot and the other of the mechanical lever or the central opening lever comprises a lug configured to be displaced within the elongated slot upon rotation of the central opening lever towards its active position by the electric release mechanism.

14. The vehicle door latch in accordance with claim 13, wherein the elongated slot has an arc shape.

15. The vehicle door latch in accordance with claim 13, wherein the lug is configured to be positioned towards an edge of the elongated slot when the central opening lever and the mechanical lever are in their rest position so that a displacement of the mechanical lever towards its active position leads to a rotation of the central opening lever towards its active position.

16. The vehicle door latch in accordance with claim 15, wherein the mechanical lever comprises an end distant from the second shaft and configured to be linked to a mechanical opening control via a cable so that a pull on the mechanical opening control leads to the displacement of the mechanical lever towards its active position.

17. The vehicle door latch in accordance with claim 16, wherein the mechanical opening control is a handle.

18. The vehicle door latch in accordance with claim 16, wherein the mechanical lever is an inner release lever and the mechanical opening control is an inner handle linked to the cable.

19. The vehicle door latch in accordance with claim 12, wherein the mechanical release mechanism further comprises an outer release lever configured to be linked to a mechanical opening control via a cable, the outer release lever being configured to be displaced from a rest position to an active position to release the retention unit, and wherein the vehicle door latch further comprises a locking mechanism comprising an electric locking motor with an output shaft, a worm arranged on the output shaft of the electric locking motor, a locking gear wheel configured to mesh with the worm to be rotated between an unlock position and a lock position, and a locking lever configured to be displaced by the locking gear wheel between a first position associated with the lock position of the locking gear wheel wherein the locking lever prevents the outer release lever from putting the retention unit in the released position and a second position associated with the unlock position of the locking gear wheel wherein the outer release lever is enabled to put the retention unit in the released position.

20. The vehicle door latch in accordance with claim 19, wherein the mechanical opening control is an outer handle.

21. The vehicle door latch in accordance with claim 19, wherein the mechanical lever is an inner release lever, and the vehicle door latch further comprises an override lever configured to move the locking lever from the locked position to the unlocked position and configured to be driven in movement by the central opening lever from the rest position to the active position or by the inner release lever from the rest position to the active position, the locking lever remaining in the unlocked position after a releasing of the door latch.

22. The vehicle door latch in accordance with claim 21, wherein the override lever is configured to displace the locking lever in the unlocked position before releasing the retention unit in the open position when the central opening lever or the inner release lever is moved from the rest position to the active position to provide a one-motion override release.

23. The vehicle door latch in accordance with claim 21, wherein the override lever is configured to displace the locking lever in the unlocked position without releasing the retention unit in the open position when the central opening lever or the inner release lever is moved from the rest position to the active position to provide a two-motion override release.

24. A vehicle door, comprising:
the vehicle door latch in accordance with claim 12.
